(19) United States
(12) Patent Application Publication
(10) Pub. No.: US 2007/0228601 A1
(43) Pub. Date: Oct. 4, 2007

(54) Method for manufacturing shoe soles from plant starch

(76) Inventor: Sung-Ho Chen, Changhua County (TW)

Correspondence Address: BIRCH STEWART KOLASCH & BIRCH, PO BOX 747, FALLS CHURCH, VA, 22040-0747, US

(21) Appl. No.: 11/394,096

(22) Filed: Mar. 31, 2006

(51) Int. Cl. B29D 31/50

(52) U.S. Cl. 264/244

(57) ABSTRACT

A method for manufacturing shoe soles from plant starch includes mixing Thermoplastic Elastomer (TPE) with plant starch, and adding a processing assistant, a dispersing assistant, a bulking agent, processing oil and an anti-oxidation agent to be mixed thoroughly in a mixer at a temperature between 30.-190.. Then the mixed materials are extruded through an extrusion machine to become granules of raw material contained the plant starch for the shoe soles. The raw material thus formed is mixed with a pigment and dying additives, then is injected through an injection machine and molds to become the shoe soles contained the plant starch. The plant starch is renewable; hence reliance on the petroleum materials is reduced. As a result, it can better meet environmental conservation and protection requirements.

### FIELD OF THE INVENTION

The present invention relates to a method for manufacturing shoe soles and particularly to a technique that mixes Thermoplastic Elastomer (TPE) with plant starch instead of petrochemical material to meet environmental protection requirement and realize sustainable resource utilization.

### BACKGROUND OF THE INVENTION

The conventional shoe soles mostly are made from manmade rubber or elastomer abstracted from petroleum. As it has desired functionality, elasticity and comfortable characteristics, its consumption grows constantly. In addition, due to pursuing economic growth has become a worldwide trend, natural resources have been exploited and consumed relentlessly. As a result, worldwide petroleum reserve dwindles at an alarming rate. With the non-renewable natural resources (such as petroleum) being wasted continuously, the awareness of environmental conservation and protection increases substantially in recent years. The concept of reducing waste of natural resources is widely accepted these days. Using renewable resources (such as plants) to reduce reliance on petroleum is a commendable approach to achieve the goal of environmental conservation and protection.

### SUMMARY OF THE INVENTION

Therefore the primary object of the present invention is to solve the disadvantages of the conventional method mentioned above and provide a method for manufacturing shoe soles from plant starch. The method includes mixing TPE with plant starch (such as potato starch, corn starch, cassava starch, wheat starch), and a processing assistant, dispersing assistant, a bulking agent, processing oil and an anti-oxidation agent in a mixer at a temperature between 30.-190.. Then the mixed materials are extruded through an extrusion machine to become granules of raw material contained the plant starch for the shoe soles. The raw material thus formed is mixed with pigment and dying additives, then is injected through an injection machine and molds at a temperature between 45.-190. to become the shoe soles contained plant starch. As the shoe soles contain plant starch, it is more environmental-friendly. Moreover, the plant starch is renewable by growing plants; hence reliance on the petroleum materials can be reduced. As a result, it can better meet environmental conservation and protection requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a flow chart of the method for manufacturing shoe soles from plant starch according to the present invention.

### DETAILED DESCRIPTION OF THE PREFERRED EMBODIMENT

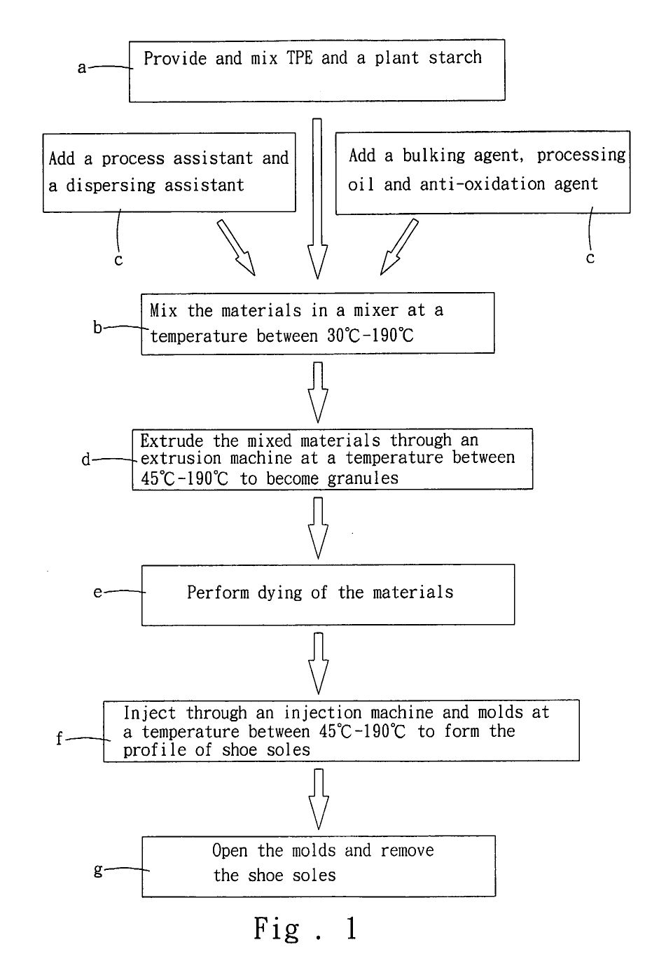

Please refer to FIG. 1 for the method of manufacturing shoe soles from plant starch. The method includes the following procedures:
a. providing raw materials that include Thermoplastic Elastomer (TPE) and plant starch (such as potato starch, corn starch, cassava starch, wheat starch);
b. mixing the raw materials in a mixer at a temperature about between 30.-190.;
c. adding a processing assistant (such as lead stearate, zinc stearate, magnesium stearate) and a dispersing assistant (such as liquid wax, paraffin wax, polythene wax) to enhance mixing of TPE and the plant starch, and adding a bulking agent (such as clay, carbonate calcium, silica, talcum powder), processing oil (such as paraffin hydrocarbon, epoxy hydrocarbon, aromatic hydrocarbon, glycerol), and an anti-oxidation agent (such as phenol-based anti-oxidation agent, phosphor-based anti-oxidation agent, sulfur-based anti-oxidation agent), and mixing the materials thoroughly;
d. extruding the mixed materials through an extrusion machine at a temperature between 45.-190. to become granules which are the raw material of the plant starch for the shoe soles;
e. performing dying process by adding pigments into the granules and mixing thoroughly at a temperature between 20. -150.;
f. injecting the dyed material through an injection machine and molds at a temperature between 45.-190. to form a profile of the shoe soles; and
g. opening the molds and removing the shoe soles.

As a portion of the raw materials of the shoe soles are obtained from plant starches that can be supplied continuously by growing plants, the concern of material depletion or exhaustion is minimized. This overcomes the problem of the conventional method that uses rubber abstracted from petrochemical processes. The concern of excessive consumption of the earth resources can also be reduced.

The method of the invention has been tested and met the object and benefits mentioned above.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for manufacturing shoe soles from plant starch, comprising the steps of:
a. providing Thermoplastic Elastomer (TPE) and a selected plant starch;
b. mixing in a mixer at a temperature between 30□-190□;
c. adding a processing assistant and a dispersing assistant to enhance mixing effect of TPE and the plant starch; adding a bulking agent, a processing oil and an anti-oxidation agent and mixing thoroughly;
d. extruding through an extrusion machine at a temperature between 45□-190□ to become granules;
e. performing dying by adding pigments in the granules and mixing at a temperature between 20□-150□;
f. injecting the dyed material through an injection machine and molds at a temperature between 45.-190. to form a profile of shoe soles; and
g. opening the molds and removing the shoe soles.

2. The method of claim 1, wherein the plant starch is selected from the group consisting of potato starch, corn starch, cassava starch and wheat starch.

3. The method of claim 1, wherein the processing assistant is selected from the group consisting of lead stearate, zinc stearate and magnesium stearate.

4. The method of claim 1, wherein the dispersing assistant is selected from the group consisting of liquid wax, paraffin wax and polythene wax.

5. The method of claim 1, wherein the bulking agent is selected from the group consisting of clay, carbonate calcium, silica and talcum powder.

6. The method of claim 1, wherein the processing oil is selected from the group consisting of paraffin hydrocarbon, epoxy hydrocarbon, aromatic hydrocarbon and glycerol.

7. The method of claim 1, wherein the anti-oxidation agent is selected from the group consisting of a phenol-based anti-oxidation agent, a phosphor-based anti-oxidation agent and a sulfur-based anti-oxidation agent.
